(19) United States
(12) Patent Application Publication
(10) Pub. No.: US 2026/0088901 A1
(43) Pub. Date: Mar. 26, 2026

(54) LAUNCHING NEW SPECTRUM CHANNELS IN FRAGMENTED OPTICAL BANDS

(71) Applicants: AT&T Intellectual Property I, L.P., Atlanta, GA (US); AT&T Communications Services India Private Limited, Bangalore (IN)

(72) Inventors: Mritunjay Pandey, Bangalore (IN); Lynn Rivera, Leesburg, VA (US); Subhash Kapoor, Wall, NJ (US)

(21) Appl. No.: 18/893,944

(22) Filed: Sep. 23, 2024

(51) Int. Cl. H04B 10/25; H04J 14/02; H04Q 11/00

(52) U.S. Cl. CPC H04B 10/25; H04J 14/0201; H04Q 11/0062; H04Q 2011/0086

(57) ABSTRACT

A method includes identifying a channel parameter and distance for a new spectrum channel to be launched in an optical band in a fiber broadband network, wherein the optical band comprises a plurality of existing spectrum channels, calculating a spectral width for the new spectrum channel, based at least in part on the channel parameter and the distance, determining that a contiguous slice of the optical band is not available to support the spectral width, identifying a set of candidate channels of the plurality of existing spectrum channels, wherein each candidate channel is a standby channel for a main channel and wherein a predicted network traffic delay associated with a movement of each candidate channel is less than a threshold delay, and marking a subset of candidate channels for movement within the optical band, where a cumulative spectral width of the subset is at least equal to the spectral width.

The present disclosure relates generally to optical network operations, and relates more particularly to devices, computer-readable media, and methods for launching new spectrum channels in fragmented optical bands.

### BACKGROUND

Dense wavelength-division multiplexing (DWDM) is an optical fiber multiplexing technology that increases the bandwidth of fiber networks. DWDM combines data signals from multiple sources over a single pair of optical fibers, but maintains separation of the data signals, which are each carried by a separate wavelength of light.

### SUMMARY

Devices, computer-readable media, and methods are disclosed for launching new spectrum channels in fragmented optical bands. In one example, a method performed by a processing system including at least one processor includes identifying a channel parameter and a distance for a new spectrum channel to be launched in an optical band in a fiber broadband network, wherein the optical band comprises a plurality of existing spectrum channels, calculating a spectral width for the new spectrum channel, based at least in part on the channel parameter and the distance, determining that a contiguous slice of the optical band is not available to support the spectral width for the new spectrum channel, identifying, in response to the determining, a set of candidate channels of the plurality of existing spectrum channels, wherein each candidate channel of the set of candidate channels is a standby channel for a main channel and wherein a predicted network traffic delay associated with a movement of each candidate channel of the set of candidate channels is less than a threshold delay, and marking a subset of candidate channels of the set of candidate channels for movement within the optical band, where a cumulative spectral width of the subset is at least equal to the spectral width for the new spectrum channel.

In another example, a non-transitory computer-readable medium stores instructions which, when executed by a processing system including at least one processor, cause the processing system to perform operations. The operations include identifying a channel parameter and a distance for a new spectrum channel to be launched in an optical band in a fiber broadband network, wherein the optical band comprises a plurality of existing spectrum channels, calculating a spectral width for the new spectrum channel, based at least in part on the channel parameter and the distance determining that a contiguous slice of the optical band is not available to support the spectral width for the new spectrum channel, identifying, in response to the determining, a set of candidate channels of the plurality of existing spectrum channels, wherein each candidate channel of the set of candidate channels is a standby channel for a main channel and wherein a predicted network traffic delay associated with a movement of each candidate channel of the set of candidate channels is less than a threshold delay, and marking a subset of candidate channels of the set of candidate channels for movement within the optical band, where a cumulative spectral width of the subset is at least equal to the spectral width for the new spectrum channel.

In another example, a system includes a processor and a non-transitory computer-readable medium storing instructions which, when executed by the processor, cause the processor to perform operations. The operations include identifying a channel parameter and a distance for a new spectrum channel to be launched in an optical band in a fiber broadband network, wherein the optical band comprises a plurality of existing spectrum channels, calculating a spectral width for the new spectrum channel, based at least in part on the channel parameter and the distance, determining that a contiguous slice of the optical band is not available to support the spectral width for the new spectrum channel, identifying, in response to the determining, a set of candidate channels of the plurality of existing spectrum channels, wherein each candidate channel of the set of candidate channels is a standby channel for a main channel and wherein a predicted network traffic delay associated with a movement of each candidate channel of the set of candidate channels is less than a threshold delay, and marking a subset of candidate channels of the set of candidate channels for movement within the optical band, where a cumulative spectral width of the subset is at least equal to the spectral width for the new spectrum channel.

### BRIEF DESCRIPTION OF THE DRAWINGS

The teaching of the present disclosure can be readily understood by considering the following detailed description in conjunction with the accompanying drawings, in which:

FIG. 1 illustrates an example system in which examples of the present disclosure for launching new spectrum channels in fragmented optical bands may operate;

FIG. 2 illustrates a flowchart of an example method for launching new spectrum channels in fragmented optical bands according to the present disclosure;

FIG. 3 illustrates a flowchart of an example method for launching new spectrum channels in fragmented optical bands according to the present disclosure; and

FIG. 4 illustrates an example high-level block diagram of a computer specifically programmed to perform the steps, functions, blocks, and/or operations described herein.

To facilitate understanding, identical reference numerals have been used, where possible, to designate identical elements that are common to the figures.

### DETAILED DESCRIPTION

The present disclosure broadly discloses devices, computer-readable media, and methods for launching new spectrum channels in fragmented optical bands. As discussed above, dense wavelength-division multiplexing (DWDM) is an optical fiber multiplexing technology that increases the bandwidth of fiber networks. DWDM combines data signals from multiple sources over a single pair of optical fibers, but maintains separation of the data signals, which are each carried by a separate channel (wavelength of light).

The use of reconfigurable optical add-drop multiplexers (ROADMs) allows individual or multiple wavelengths carrying data channels to be added and/or dropped from an optical fiber without the need to convert the data signals on all of the WDM channels to electronic signals and back again to optical signals. Many current generation ROADMs employ flexible grid (or “flex-grid”) functionality, which allows an operator of a DWDM network to define the spectral width of each channel independently over a continuous 4,800 gigahertz (GHz) block of spectrum (as opposed to, for instance, pre-partitioning the block of spectrum into a fixed number of slots of equal spectral width, such as 50 GHz). The network operator can define individual spectral slots to meet the spectral width of each individual channel.

If the spectral slots are not planned carefully, however, this can lead to fragmentation within the optical band, or small bands of spectrum that are effectively unusable. Most channels require at least a 50 GHz spectral width in order to provide a minimum of 100 Gb/s capacity over a typical metro DWDM network. If unassigned spectrum components that are not at least 50 GHz are left between spectrum components that are assigned to channels, these unassigned spectrum components will not provide the needed spectral width to support a new channel. Thus, the unassigned spectrum components will be wasted. Moreover, when the network operator wishes to launch a new channel, the optical band may not be able to provide sufficient contiguous spectrum to accommodate the spectral width of the new channel, even though, collectively, a plurality of unassigned spectrum components may provide the needed spectral width.

Examples of the present disclosure provide a software defined controller that is capable of learning the topology of a DWDM network and using that knowledge to determine an optimal allocation of the optical band to a new channel. This optimal allocation may involve moving one or more existing channels of the DWDM within the optical band (e.g., reallocating spectrum components of the optical band among the one or more existing channels) to accommodate the launch of the new channel. In addition to moving one or more of the existing channels, the software defined controller may also be able to tune other components of the DWDM network, such as lasers, amplifiers, wavelength selective switches (WSSs), optical performance monitoring (OPM) systems, and the like. The knowledge of network topology and the ability to tune the DWDM network components may allow the software defined controller to accommodate the launch of the new channel with minimal disruption to traffic propagating over the DWDM network.

In further examples of the present disclosure, the software defined controller may proactively predict when fragmentation of the optical band is likely to occur or to lead to wastage of spectral components, and may generate a recommendation to defragment the optical band (e.g., reallocate the spectral components among the existing channels) during a window for network maintenance.

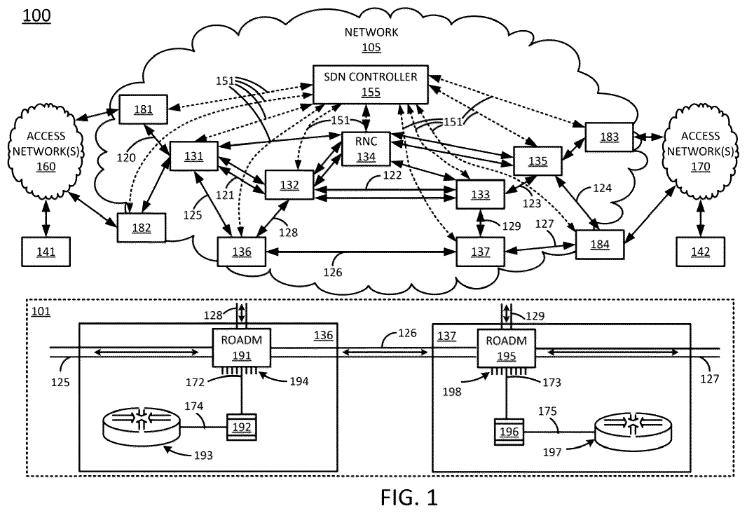

In some examples, machine learning techniques such as large language models and neural networks could be used to learn the topology of a fiber broadband network and to predict optimal movements of spectrum channels within optical bands of the fiber broadband network to minimize network disruptions (e.g., traffic delays) and allow for the launch of new spectrum channels within the optical bands. As the machine learning model learns the optimal movements of spectrum channels, a database may be built to facilitate adapting the fiber broadband network for DWDM cross-frequency channel communications and make more efficient use of valuable spectrum bands. These and other aspects of the present disclosure are discussed in greater detail below in connection with the examples of FIGS. 1-4.

To aid in understanding the present disclosure, FIG. 1 illustrates an example system 100 in which examples of the present disclosure for launching new spectrum channels in fragmented optical bands may operate. The overall communications system 100 may include any number of interconnected networks which may use the same or different communication technologies. As illustrated in FIG. 1, system 100 may include a network 105, e.g., a core telecommunication network. In one example, the network 105 may comprise a backbone network, or transport network, such as an Internet Protocol (IP)/Multi-Protocol Label Switching (MPLS) network, where label switched paths (LSPs) can be assigned for routing Transmission Control Protocol (TCP)/IP packets, User Datagram Protocol (UDP)/IP packets, and other types of protocol data units (PDUs) (broadly “traffic”). However, it will be appreciated that the present disclosure is equally applicable to other types of data units and network protocols. For instance, the network 105 may utilize IP routing (e.g., without MPLS). Furthermore, network 105 may comprise multiple networks utilizing different protocols, all utilizing a shared underlying WDM infrastructure (fibers, amplifiers, ROADMs, etc.), e.g., an optical transport network. In this regard, it should be noted that as referred to herein, “traffic” may comprise all or a portion of a transmission, e.g., a sequence or flow, comprising one or more packets, segments, datagrams, frames, cells, PDUs, service data units, bursts, and so forth. The particular terminology or types of data units involved may vary depending upon the underlying network technology. Thus, the term “traffic” is intended to refer to any quantity of data to be sent from a source to a destination through one or more networks.

In one example, the network 105 may be in communication with networks 160 and networks 170. Networks 160 and 170 may comprise wireless networks (e.g., Institute of Electrical and Electronics Engineers (IEEE) 802.11/Wi-Fi networks and the like), cellular access networks (e.g., Universal Terrestrial Radio Access Networks (UTRANs) or evolved UTRANs (eUTRANs), and the like), circuit switched networks (e.g., public switched telephone networks (PSTNs)), cable networks, digital subscriber line (DSL) networks, metropolitan area networks (MANs), Internet service provider (ISP) networks, peer networks, and the like. In one example, the networks 160 and 170 may include different types of networks. In another example, the networks 160 and 170 may be the same type of network. The networks 160 and 170 may be controlled or operated by a same entity as that of network 105 or may be controlled or operated by one or more different entities. In one example, the networks 160 and 170 may comprise separate domains, e.g., separate routing domains as compared to the network 105. In one example, networks 160 and/or networks 170 may represent the Internet in general.

In one example, network 105 may transport traffic to and from user devices 141 and 142. For instance, the traffic may relate to communications such as voice telephone calls, video and other multimedia, text messaging, emails, and so forth between the user devices 141 and 142, or between the user devices 141 and/or 142 and other devices that may be accessible via networks 160 and 170. User devices 141 and 142 may comprise, for example, cellular telephones, smart phones, personal computers, other wireless and wired computing devices, private branch exchanges, customer edge (CE) routers, media terminal adapters, cable boxes, home gateways and/or routers, and so forth.

As stated above, network 105 comprises a WDM network (e.g., DWDM or CWDM network). Accordingly, in one example, the nodes 131-137 may include optical components, such as reconfigurable add/drop multiplexers (ROADMs), and the links between nodes 131-137 may comprise fiber optic cables. Software-controlled ROADMs manage data traveling over high-capacity fiber optic lines and can automatically detect and adjust bandwidth, move traffic to different lanes, turn off wavelengths for a variety of different reasons, and so forth. Generally, each ROADM is connected to one or more other ROADMs by one or more optical fiber pairs. A given ROADM will transmit an optical signal on one fiber in a pair and receive a return signal on the other fiber in the pair; thus, each optical fiber transmits in a single direction. A Layer 1 service, or a wavelength, can then be set up between two transponders, where each transponder is connected to a nearby ROADM. The wavelength may then be routed through the ROADM network.

For ease of illustration, a portion of the links is specifically labeled as links 120-129. Inset 101 illustrates a portion of the network 105 comprising nodes 136 and 137, and links 125-129. As shown in inset 101, node 136 includes a ROADM 191 coupled to links 125, 126, and 128, a plurality of add/drop ports 194, and a router 193 coupled to the ROADM 191 via one of the plurality of add/drop ports 194 and a transponder 192 via a patch cord 172. Similarly, node 137 includes a ROADM 195 coupled to links 126, 127, and 129, a plurality of add/drop ports 198, and a network switch 197 coupled to ROADM 195 via a patch cord 173 between one of the plurality of add/drop ports 198, and a transponder 196.

In one example, one or both of the transponders 192 and 196 may comprise a muxponder that may aggregate several lower bandwidth signals from one or more network switches, routers, or other client devices at node 136 or node 137 into a combined signal for transmission over one of the network links 125, 126, 127, 128, or 129. In one example, one or both of the transponders 192 and 196 may be capable of transmitting and/or receiving optical signals for use in metro or transport applications at data rates of 100 Gb/s or greater. However, in another example, one or both of the transponders 192 and 196 may transmit and receive at lower data rates, such as 25 Gb/s, 10 Gb/s etc. ROADMs 191 and 195 may comprise colorless ROADMs, directionless ROADMs, colorless and directionless ROADMs (CD ROADMs), contentionless ROADMs, e.g., colorless, directionless, and contentionless (CDC) ROADMs, and so forth. Additionally, it should be noted that these ROADMs may include Open ROADMs with open standards allowing interoperability of different ROADMs manufactured by different vendors.

It should be noted that in each of the nodes 136 and 137, any number of routers, switches, application servers, and the like may be connected to one of the plurality of add/drop ports 194 or plurality of add/drop ports 198, e.g., via additional transponders and/or transceivers. In addition, in other examples, additional components, such as additional ROADMs, may be connected to one of the plurality of add/drop ports 194 or plurality of add/drop ports 198. For instance, in another example, node 137 may include a number of ROADMs, wavelength selective switches (WSSs), and other components that are interconnected to provide a higher degree node. In addition, as referred to herein the terms “switch” and “network switch” may refer to any of a number of similar devices, e.g., including: a Layer 2 switch (e.g., an Ethernet switch), a Layer 3 switch/multi-layer switch, a router (e.g., a router which may also include switching functions), or the like. It should also be noted that nodes 131-135 may have a same or similar setup as nodes 136 and 137. In addition, in one example, any one or more of components 181-184 may also comprise an optical node with a same or similar setup as nodes 136 and 137.

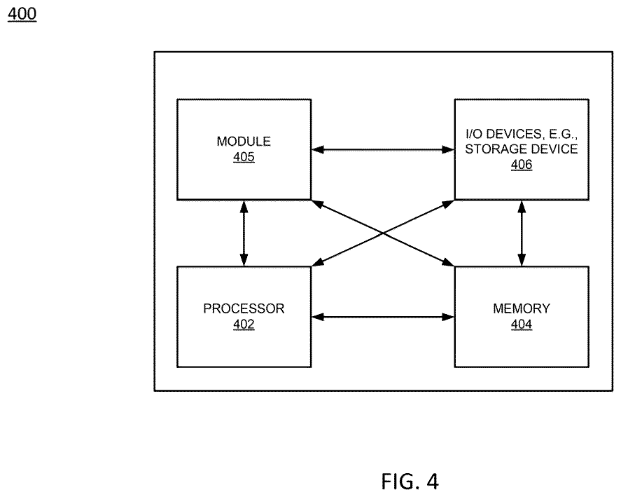

As further illustrated in FIG. 1, network 105 includes a software defined network (SDN) controller 155 and a ROADM network controller (RNC) 134. In one example, the SDN controller 155 may comprise a computing system or server, such as computing system 400 depicted in FIG. 4, and may be configured to provide one or more operations or functions for launching new spectrum channels in fragmented optical bands. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., a computing system as illustrated in FIG. 4 and discussed below) or multiple computing devices collectively configured to perform various steps, functions, and/or operations in accordance with the present disclosure. In addition, with respect to ROADMs, “configured” and “reconfigured” may refer to instructions to adjust a WSS to route different wavelengths to different fibers/links and/or to different add/drop ports. With respect to network switches and transponders, “configured” and “reconfigured” may refer to instructions to send or receive at a particular bitrate, to utilize a particular transmit power, to transmit or receive on a particular wavelength, and the like.

In one example, nodes 131-137 and components 181-184 (and/or the devices therein) may be controlled and managed by SDN controller 155. For instance, in one example, SDN controller 155 is responsible for such functions as provisioning and releasing instantiations of virtual network functions (VNFs) to perform the functions of routers, switches, and other devices, provisioning routing tables and other operating parameters for the VNFs, and so forth. Thus, various components of network 105 may comprise virtual network functions which may physically comprise hardware executing computer-readable/computer-executable instructions, code, and/or programs to perform various functions. For example, the functions of SDN controller 155 may include the selection of a network function virtualization infrastructure (NFVI) from among various NFVIs available at nodes 131-137 in network 105 to host various devices, such as routers, gateways, switches, route reflectors, firewalls, media servers, and so forth. To illustrate, network switches 193 and 197 may physically reside on host devices that may be configured to be a firewall, a media server, a network switch, a router, and so forth.

In addition, SDN controller 155 may also manage the operations of optical components of the network 105. For instance, SDN controller 155 may configure paths for wavelength connections via the network 105 by configuring and reconfiguring ROADMs at nodes 131-137 and components 181-184. For example, SDN controller 155 may provide instructions to control WSSs within the ROADMs, as well as transceivers and/or transponders connected to the ROADM add/drop ports. In one example, SDN controller 155 may maintain communications with nodes 131-137 and components 181-184 (and/or the devices therein) via a number of control links 151 which may comprise secure tunnels for signaling communications over an underlying IP infrastructure of network 105, e.g., including fibers/links 120-129, etc. In other words, the control links 151 may comprise virtual links multiplexed with transmission traffic and other data traversing network 105 and carried over a shared set of physical links. Alternatively, or in addition, the control links 151 may comprise out-of-band links, e.g., optical or non-optical connections that are different from fibers/links 120-129.

In one example, SDN controller 155 may be in communication with the RNC 134. For example, RNC 134 may be responsible for instantiating and releasing instances of virtual machines at nodes 131-137 and for configuring and reconfiguring operations of associated ROADMs, such as ROADMs 191 and 195, transponders 192 and 196, and other devices at the nodes 131-137 such as transceivers, network switches, and so on. Alternatively, the RNC may control respective node controllers at the nodes 131-137 to instantiate and release instances of virtual machines and to configure and reconfigure devices at the nodes 131-137. Thus, in one example, RNC 134 may receive instructions for configuring and reconfiguring ROADMs 191 and 195 from SDN controller 155, e.g., via control links 151. Alternatively, or in addition, control links 151 may provide connections between SDN controller 155 and ROADMs 191 and 195, transponders 192 and 196, and other devices at the nodes such as transceivers and network switches without the involvement of the RNC 134 and/or individual node controllers. In one example, the SDN controller 155 may also comprise a virtual machine operating on one or more NFVI/host devices, or may comprise one or more dedicated devices. For instance, SDN controller 155 may be collocated with one or more VNFs, may be deployed in one or more different host devices, or at a different physical location or locations, and so forth.

In addition, in one example, SDN controller 155 may represent a processing system comprising a plurality of controllers, e.g., a multi-layer SDN controller, one or more federated Layer 0/physical layer SDN controllers, and so forth. For instance, a multi-layer SDN controller may be responsible for instantiating, tearing down, configuring, reconfiguring, and/or managing Layer 2 and/or Layer 3 VNFs (e.g., a network switch, a Layer 3 switch and/or a router, etc.), whereas one or more Layer 0 SDN controllers may be responsible for activating and deactivating optical networking components, for configuring and reconfiguring the optical networking components (e.g., to provide circuits/wavelength connections between various nodes or to be placed in idle mode), for receiving management and configuration information from such devices, for instructing optical devices at various nodes to provision optical network paths in accordance with the present disclosure, and so forth. In one example, the Layer 0 SDN controller(s) may in turn be controlled by the multi-layer SDN controller. For instance, each Layer 0 SDN controller may be assigned to nodes/optical components within a portion of the network 105. In addition, these various components may be co-located or distributed among a plurality of different dedicated computing devices or shared computing devices (e.g., NFVI) as described herein.

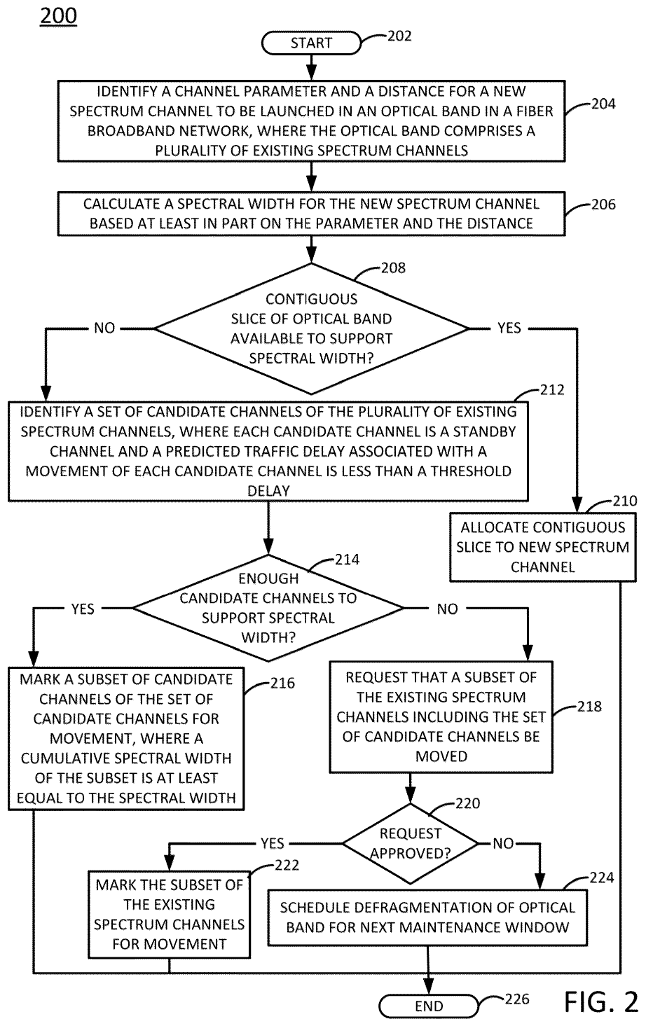

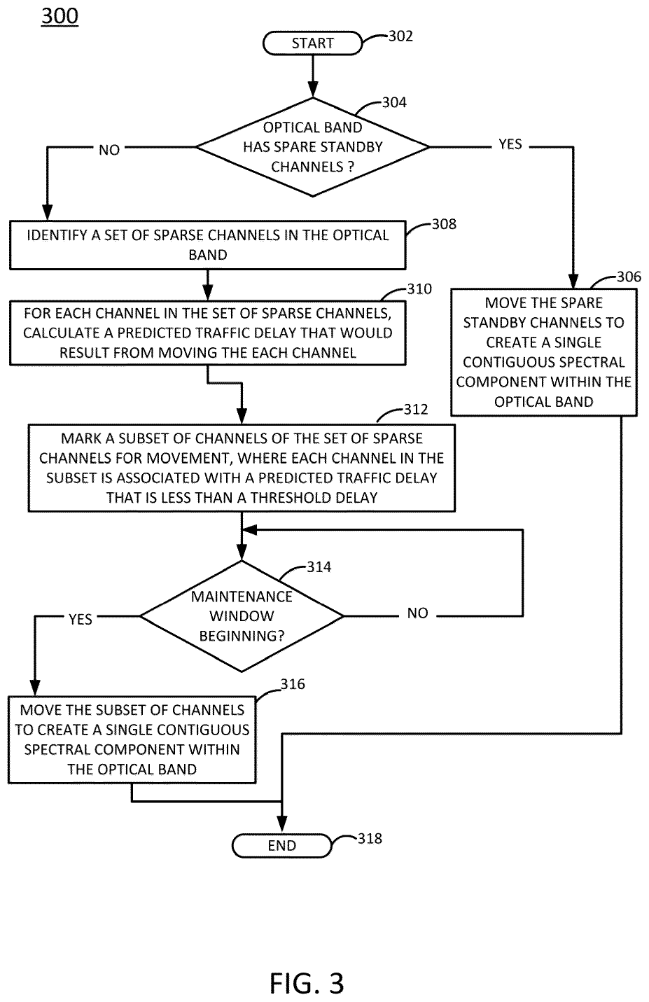

In one example, the SDN controller 155 may be configured to perform operations in connection with examples of the present disclosure for launching new spectrum channels in fragmented optical bands. For instance, in one example, the SDN controller 155 may discover and maintain a topology (e.g., in a database) of the system 100, including locations and optical parameters of the nodes 131-137, locations and parameters of the links 120-129, optical bands supported by all of the links 120-129, and spectrum channels currently occupying spectral components of the optical bands, and may determine movements of spectrum channels in order to accommodate the launches of new spectrum channels and/or defragmentation of optical bands, as discussed in further detail with respect to FIG. 2 and FIG. 3.

It should be noted that the system 100 has been simplified. In other words, the system 100 may be implemented in a different form than that illustrated in FIG. 1. For example, the system 100 may be expanded to include additional networks and additional network elements (not shown) such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions and/or combine elements that are illustrated as separate devices. For example, SDN controller 155, RNC 134, and/or other network elements may comprise functions that are spread across several devices that operate collectively as a SDN controller, an RNC, etc. In another example, RNC 134 and SDN controller 155 may be integrated into a single device. In another example, RNC 134 may maintain its own connections to nodes 131-137 and components 181-184 and may send instructions to various devices to dynamically scale the capacity of the network 105 in accordance with the present disclosure. In another example, nodes 131-137 and/or components 181-184 may include fiber loss test sets (FLTSs), optical time domain reflectometers (OTDRs), polarization mode dispersion (PMD) measurement devices, and the like which may be used to measure fiber loss and PMD over various links.

In addition, the foregoing includes examples where operations for launching new spectrum channels in fragmented optical bands may be performed by RNC 134, and/or by RNC 134 in conjunction with other devices under the control and instruction of SDN controller 155. However, in other, further, and different examples, aspects of launching new spectrum channels in fragmented optical bands may include transponders and/or network switches performing one or more operations autonomously. Thus, these and other modifications of the system 100 are all contemplated within the scope of the present disclosure.

FIG. 2 illustrates a flowchart of an example method 200 for launching new spectrum channels in fragmented optical bands according to the present disclosure. In one example, steps, functions and/or operations of the method 200 may be performed by a network-based device, such as SDN controller 155 in FIG. 1, or any one or more components thereof, such as a processing system. Alternatively, or in addition, the steps, functions and/or operations of the method 200 may be performed by the RNC 134 of FIG. 1 or any one of more components thereof, by a computing device or system 400, and/or a processing system 402 as described in connection with FIG. 4 below. For illustrative purposes, the method 200 is described in greater detail below in connection with an example performed by a processing system.

The method 200 begins in step 202. In step 204, the processing system may identify a channel parameter and a distance for a new spectrum channel to be launched in an optical band in a fiber broadband network, where the optical band comprises a plurality of existing spectrum channels.

In one example, the fiber broadband network is a DWDM network employing a ROADM flex-grid. Fragmentation may exist in the optical band, for instance in the conventional (“C”) band (e.g., spanning the 1530-1565 nm wavelength range) and/or the long (“L”) band (e.g., spanning the1565-1625 nm wavelength range).

In one example, the channel parameter may comprise a threshold (e.g., minimum or maximum) bandwidth of the new spectrum channel; however, in other examples, the channel parameter may comprise a different parameter of the new spectrum channel, such as a maximum latency, a maximum packet loss, a maximum jitter, a threshold data rate, a supported modulation format, a supported data rate, a supported data type, a supported forward error correction (FEC) format, a gain profile, an absorption loss, a scattering phenomena, a linear impairment phenomenon, a non-linear impairment phenomenon, an optical fiber mode type, an optical material characteristic, a refractive index type, a distance between a source node and a destination node of the channel, a number of fiber connectors and splices of the channel, a spectral efficiency, an asymptotic power efficiency, an average energy, stimulated Brillouin scattering (SBS), Stimulated Raman scattering (SRS), a dispersion profile (e.g., chromatic, polarization mode dispersion, and model), a log, a network element data model, a vendor-specific golden configuration specification, or the like. The distance for the new spectrum channel comprises an end-to-end physical distance between endpoints of the new spectrum channel (e.g., the length of the fiber broadband network link associated with the optical band).

In step 206, the processing system may calculate a spectral width for the new spectrum channel, based at least in part on the channel parameter and the distance. In one example, the spectral width may be calculated based upon a number of considerations in addition to the channel parameter and the distance, including dispersion in the optical fiber that supports the optical band, attenuation in the optical fiber, one or more non-linear parameters of the optical fiber, a FEC format of the optical fiber (e.g., standard, enhanced, adaptive, or the like), a modulation format of the optical fiber (e.g., 64QAM, 32QAM, PS-QPSK, or the like) and/or other considerations. Based on these considerations, the processing system may calculate the spectral width (e.g., in GHz) needed to launch the new spectrum channel.

In step 208, the processing system may determine whether a contiguous slice of the optical band is available to support the spectral width that is calculated. In order to launch the new spectrum channel, a single contiguous slice of the optical band that is at least as wide as the spectral width calculated in step 206 will need to be available. A slice of the optical band is considered to be “available” if the slice is not currently supporting an existing spectrum channel (e.g., is unused). Prior to execution of the method 200, the processing system may have performed a discovery process to learn the topology of the fiber broadband network, including all optical fibers and their corresponding optical bands, all existing spectrum channels currently operating within all optical bands, and all unused spectral components of all optical bands.

The discovery process may also allow the processing system to learn various attributes of each channel of the existing spectrum channels, including: how many slices of the optical band (e.g., 6.5 MHz slices), the channel spans, central frequencies of the channel, end-to-end physical length of the channel (e.g., in kilometers or other units of measure), if the channel is a main channel or a standby channel, data rate supported by the channel, protocol supported by the channel, FEC type supported by the channel, number of hops or ROADM nodes along the channel, and/or predicted network traffic delay (e.g., quantified in milliseconds) associated with moving the channel. Knowledge of these attributes may help the processing system to determine whether it is feasible to move an existing spectrum channel to a new slice of the optical band and re-allocate the slice of the optical band that was previously occupied by the existing spectrum channel's to the new spectrum channel, as discussed in greater detail below. Feasibility may depend on the requirements of the new spectrum channel, the capabilities of the existing spectrum channel, and/or the impact on traffic in the fiber broadband channel if the existing spectrum channel is moved.

If the processing system concludes in step 208 that a contiguous slice of the optical band is available to support the spectral width that is calculated, then the method 200 may proceed to step 210. In step 210, the processing system may allocate the contiguous slice of the optical band to the new spectrum channel.

In one example, allocation of the contiguous slice of the optical band includes launching the new spectrum channel on the contiguous slice. When the new spectrum channel is launched, the processing system may update any topological information that the processing system maintains for the fiber broadband network (e.g., as discussed above in connection with step 208).

Once the contiguous slice is allocated to the new spectrum channel, the method 200 may end in step 226.

If, however, the processing system concludes in step 208 that a contiguous slice of the optical band is not available to support the spectral width that is calculated, then the method 200 may proceed to step 212. In step 212, the processing system may identify a set of candidate channels of the plurality of existing spectrum channels, wherein each candidate channel of the set of candidate channels is a standby channel for a main channel and wherein a predicted network traffic delay associated with a movement of each candidate channel of the set of candidate channels is less than a threshold delay.

In some examples, the plurality of existing spectrum channels may include main channels and standby channels. In one example, there may be a one-to-one correspondence between main channels and standby channels. In this case, each main channel may be associated with one standby channel. In some cases, the standby channel may be used to send network traffic that would normally be sent over the main channel when there is a failure on the main channel (e.g., such that the standby channel provides redundancy for the main channel). Thus, in many cases, network traffic may traverse a standby channel on an infrequent basis.

In one example, the threshold delay may be fifty milliseconds or other threshold delay settings (e.g., fifty five milliseconds, forty five milliseconds, etc.). Thus, every candidate channel in the set of candidate channels will satisfy two conditions: (1) the channel will be a standby channel for a main channel; and (2) the predicted delay in network traffic resulting from moving the candidate channel to another slice of the optical band is less than the threshold delay.

In step 214, the processing system may determine whether there are enough candidate channels in the set of candidate channels to support the spectral width of the new spectrum channel. In one example, there are enough candidate channels to support the spectral width of the new spectrum channel if movement of a subset of the set of candidate channels would vacate a single slice of the optical band that is at least as wide as the spectral width of the new spectrum channel.

If the processing system concludes in step 214 that there are enough candidate channels in the set of candidate channels to support the spectral width of the new spectrum channel, then the method 200 may proceed to step 216. In step 216, the processing system may mark a subset of candidate channels of the set of candidate channels for movement, where a cumulative spectral width of the subset is at least equal to the spectral width of the new spectrum channel.

In one example, marking the subset of the candidate channels may comprise flagging the candidate channels that are members of the subset in a topology database for the fiber broadband network. Flagging may include identifying, for each candidate channel that is a member of the subset, a current (or source) location of the candidate channel in the optical band and a new (or destination) location in the optical band to which the candidate channel is to be moved to accommodate the new spectrum channel.

In another example, the processing system may initiate an action to move each candidate channel in the subset (e.g., by issuing commands to the endpoints of each candidate channel, where the endpoints may be ROADMs or other network elements, and the commands instruct the endpoints to direct network traffic destined for each candidate channel over a new block of spectrum in the optical band).

Once the subset of candidate channels has been moved, the method 200 may end in step 226.

If, however, the processing system concludes in step 214 that there are not enough candidate channels in the set of candidate channels to support the spectral width of the new spectrum channel, then the method 200 may proceed to step 218. In step 218, the processing system may request that a subset of the existing spectrum channels including the set of candidate channels be moved, where a cumulative spectral width of the subset is at least equal to the spectral width of the new spectrum channel.

In one example, if there are not enough candidate channels meeting the criteria described above in connection with step 212 to cumulatively provide the needed spectral width for the new spectrum channel, then the processing system may supplement the set of candidate channels with one or more main channels. In one example, the one or more main channels may comprise main channels for which the predicted network traffic delay associated with movement of the main channel is less than the threshold delay. However, in other examples, the predicted network traffic delay associated with movement of the one or more main channels may be greater than the threshold delay (but lower than predicted network traffic delays associated with movement of other main channels of the existing spectrum channels).

In one example, the request may be sent to an operator of the fiber broadband network, who must manually approve moving all of the existing spectrum channels in the subset. In a further example, the request may include the predicted network traffic delay that is associated with movement of all of the existing spectrum channels in the subset, so that the operator may make an educated judgment as to whether the accommodation of the new spectrum channel is worth the predicted impact to the fiber broadband network.

In step 220, the processing system may determine whether the request was approved. For instance, the processing system may receive a response to the request that indicates whether the operator has approved or declined the proposal to move the subset of the existing spectrum channels including the set of candidate channels.

If the processing system concludes in step 220 that the request was approved, then the method 200 may proceed to step 222. In step 222, the processing system may mark the subset of the existing spectrum channels for movement.

In one example, marking the subset of the existing spectrum channels may comprise flagging the channels that are members of the subset in a topology database for the fiber broadband network. Flagging may include identifying, for each existing spectrum channel that is a member of the subset, a current (or source) location of the existing spectrum channel in the optical band and a new (or destination) location in the optical band to which the existing spectrum channel is to be moved to accommodate the new spectrum channel.

In another example, the processing system may initiate an action to move each existing spectrum channel in the subset (e.g., by issuing commands to the endpoints of each existing spectrum channel, where the endpoints may be ROADMs or other network elements, and the commands instruct the endpoints to direct network traffic destined for each existing spectrum channel over a new block of spectrum in the optical band).

Once the subset of the existing spectrum channels has been moved, the method 200 may end in step 226.

If, however, the processing system concludes in step 220 that the request was not approved, then the method 200 may proceed to step 224. In step 224, the processing system may schedule a defragmentation of the optical band for a next scheduled maintenance window for the fiber broadband network.

In one example, defragmentation may comprise reevaluating the spectral components of the optical band to assign to each of the existing spectrum channels and to the new spectrum channel. Thus, defragmentation may result in a plurality of spectrum channels being reassigned to new spectral components of the optical band. One example of a method for defragmenting an optical band is discussed in greater detail in connection with FIG. 3, below. Scheduling the defragmentation to occur during a maintenance window may limit the impact that the movement of spectrum channels during defragmentation has on the network traffic traversing the fiber broadband network (e.g., in terms of delay).

Once the defragmentation has been scheduled, the method 200 may end in step 226.

FIG. 3 illustrates a flowchart of an example method 300 for launching new spectrum channels in fragmented optical bands according to the present disclosure. In one example, steps, functions and/or operations of the method 300 may be performed by a network-based device, such as SDN controller 155 in FIG. 1, or any one or more components thereof, such as a processing system. Alternatively, or in addition, the steps, functions and/or operations of the method 300 may be performed by the RNC 134 of FIG. 1 or any one of more components thereof, by a computing device or system 400, and/or a processing system 402 as described in connection with FIG. 4 below. For illustrative purposes, the method 300 is described in greater detail below in connection with an example performed by a processing system.

The method 300 begins in step 302. In step 304, the processing system may determine whether an optical band of a fiber broadband network link has any spare standby channels.

In one example, the fiber broadband network is a DWDM network employing a ROADM flex-grid. Fragmentation may exist in the optical band, for instance in the conventional (“C”) band (e.g., spanning the 1530-1565 nm wavelength range) and/or the long (“L”) band (e.g., spanning the1565-1625 nm wavelength range). For instance, the optical band may include a plurality of main channels and a plurality of standby channels that provide redundancy for the plurality of main channels. However, if a standby channel is not currently active (e.g., not currently carrying data that would normally be carried by the corresponding main channel), then the standby channel may be considered a “spare” standby channel for the purposes of defragmentation.

If the processing system concludes in step 304 that the optical band of the fiber broadband network link does have spare standby channels, then the method 300 may proceed to step 306. In step 306, the processing system may move the spare standby channels to create a single contiguous spectral component within the optical band.

For instance, the spare standby channels may not be adjacent to each other prior to step 306. However, if moved to new locations in the optical band that allow the spare standby channels to be adjacent to each other, the spare standby channels may cumulatively form a single contiguous spectral component,

Once the single contiguous spectral component is created, the method 300 may end in step 318.

If, however, the processing system concludes in step 304 that the optical band of the fiber broadband network link does not have spare standby channels, then the method 300 may proceed to step 308. In step 308, the processing system may identify a set of sparse channels in the optical band.

Within the context of the present disclosure, sparse channels may be main channels or unused spectral components of the optical band that are scattered throughout the optical band (e.g., not adjacent to each other).

In step 310, the processing system may calculate, for each channel in the set of sparse channels, a predicted traffic delay that would result from moving the each channel. In one example, the delay may be predicted in milliseconds and represents the delay that would be experienced by network traffic currently traversing the fiber broadband network as a result of the each sparse channel being moved to form the single contiguous spectral component.

In step 312, the processing system may mark a subset of channels of the set of sparse channels for movement, where each channel in the subset is associated with a predicted traffic delay that is less than a threshold delay.

In one example, marking the subset of the channels may comprise flagging the channels that are members of the subset in a topology database for the fiber broadband network. Flagging may include identifying, for each channel that is a member of the subset, a current (or source) location of the channel in the optical band and a new (or destination) location in the optical band to which the channel is to be moved.

In step 314, the processing system may determine whether a maintenance window is beginning. In one example, periodic maintenance may be scheduled for the fiber broadband network. Maintenance of the fiber broadband network may occur during predefined maintenance windows. These maintenance windows may provide an optimal time to perform defragmentation with minimal further disruption to the network traffic. The processing system may have access to a schedule that indicates when each predefined maintenance window is to begin and to end.

If the processing system concludes in step 314 that the maintenance window is not beginning, then the method 300 may return to step 314, and the processing system may wait for the maintenance window to begin.

If, however, the processing system concludes in step 314 that the maintenance window is beginning, then the method 300 may proceed to step 316. In step 316, the processing system may move the subset of channels to create a single contiguous spectral component within the optical band.

In one example, the processing system may initiate an action to move each channel in the subset (e.g., by issuing commands to the endpoints of each channel, where the endpoints may be ROADMs or other network elements, and the commands instruct the endpoints to direct network traffic destined for each channel over a new block of spectrum in the optical band).

Once the single contiguous spectral component is created, the method 300 may end in step 318.

It should be noted that the method 200 or the method 300 may be expanded to include additional steps or may be modified to include additional operations with respect to the steps outlined above. For instance, although not specifically specified, one or more steps, functions, or operations of the method 200 or the method 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 or FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for launching new spectrum channels in fragmented optical bands, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 406 may also include antenna elements, transceivers, power units, and so forth. Although only one processor element is shown, it should be noted that the computing device may employ a plurality of processor elements. Furthermore, although only one computing device is shown in the figure, if the method 200 or method 300 as discussed above is implemented in a distributed or parallel manner for a particular illustrative example, i.e., the steps of the above method 200 or 300, or the entire method 200 or 300 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the methods discussed above can be used to configure a hardware processor to perform the steps, functions and/or operations of the above disclosed method 200 or method 300. In one example, instructions and data for the present module or process 405 for launching new spectrum channels in fragmented optical bands (e.g., a software program comprising computer-executable instructions) can be loaded into memory 404 and executed by hardware processor element 402 to implement the steps, functions, or operations as discussed above in connection with the illustrative method 200 or method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for launching new spectrum channels in fragmented optical bands (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
identifying, by a processing system including at least one processor, a channel parameter and a distance for a new spectrum channel to be launched in an optical band in a fiber broadband network, wherein the optical band comprises a plurality of existing spectrum channels;
calculating, by the processing system, a spectral width for the new spectrum channel, based at least in part on the channel parameter and the distance;
determining, by the processing system, that a contiguous slice of the optical band is not available to support the spectral width for the new spectrum channel;
identifying, by the processing system in response to the determining, a set of candidate channels of the plurality of existing spectrum channels, wherein each candidate channel of the set of candidate channels is a standby channel for a main channel and wherein a predicted network traffic delay associated with a movement of each candidate channel of the set of candidate channels is less than a threshold delay; and
marking, by the processing system, a subset of candidate channels of the set of candidate channels for movement within the optical band.

2. The method of claim 1, wherein a cumulative spectral width of the subset is at least equal to the spectral width for the new spectrum channel.

3. The method of claim 1, wherein the fiber broadband network is a wavelength division multiplexing network employing a reconfigurable optical add/drop multiplexer flexible grid.

4. The method of claim 1, wherein the channel parameter comprises at least one of: a threshold bandwidth of the new spectrum channel, a maximum latency of the new spectrum channel, a maximum packet loss of the new spectrum channel, a maximum jitter of the new spectrum channel, or a threshold data rate of the new spectrum channel.

5. The method of claim 1, wherein the spectral width is additionally calculated based on at least one of: a dispersion in an optical fiber that supports the optical band, an attenuation in the optical fiber, a non-linear parameter of the optical fiber, a forward error correction format of the optical fiber, or a modulation format of the optical fiber.

6. The method of claim 1, wherein the marking comprises flagging each candidate channel that is a member of the subset in a topology database for the fiber broadband network, and wherein the flagging comprises identifying a current location of the each candidate channel in the optical band and a new location in the optical band to which the each candidate channel is to be moved to accommodate the new spectrum channel.

7. The method of claim 1, wherein the marking comprises issuing commands to endpoints of each candidate channel that is a member of the subset, wherein the commands cause the each candidate channel that is a member of the subset to be moved.

8. The method of claim 1, wherein the subset of candidate channels is augmented with at least one main channel within the optical band, and wherein a cumulative spectral width of the subset augmented with the at least one main channel is at least equal to the spectral width for the new spectrum channel.

9. The method of claim 8, wherein a predicted network traffic delay associated with a movement of the at least one main channel is less than the threshold delay.

10. The method of claim 8, further comprising:
sending a request that a subset of the existing spectrum channels comprising the subset of the set of candidate channels and the at least one main channel be moved.

11. The method of claim 10, wherein the request is sent to an operator of the fiber broadband network.

12. The method of claim 11, wherein the request is approved, and the marking further comprises marking the at least one main channel for movement within the optical band.

13. The method of claim 11, wherein the request is declined, and the method further comprises:
scheduling, by the processing system, a defragmentation of the optical band.

14. The method of claim 13, wherein the defragmentation is scheduled for a next maintenance window for the fiber broadband network.

15. The method of claim 13, wherein the defragmentation comprises:
identifying, by the processing system, a set of sparse channels in the optical band;
calculating, by the processing system for each channel in the set of sparse channels, a predicted traffic delay that would result from moving the each channel; and
marking, by the processing system, a subset of channels of the set of sparse channels for movement, where each channel in the subset of channels of the set of sparse channels is associated with a predicted traffic delay that is less than a second threshold delay.

16. The method of claim 15, wherein each sparse channel in the set of sparse channels comprises an unused spectral component of the optical band.

17. The method of claim 16, wherein no sparse channels in the set of sparse channels are adjacent to each other in the optical band.

18. The method of claim 1, wherein the threshold delay is fifty milliseconds.

19. A non-transitory computer-readable medium storing instructions which, when executed by a processing system including at least one processor, cause the processing system to perform operations, the operations comprising:
identifying a channel parameter and a distance for a new spectrum channel to be launched in an optical band in a fiber broadband network, wherein the optical band comprises a plurality of existing spectrum channels;
calculating a spectral width for the new spectrum channel, based at least in part on the channel parameter and the distance;
determining that a contiguous slice of the optical band is not available to support the spectral width for the new spectrum channel;
identifying, in response to the determining, a set of candidate channels of the plurality of existing spectrum channels, wherein each candidate channel of the set of candidate channels is a standby channel for a main channel and wherein a predicted network traffic delay associated with a movement of each candidate channel of the set of candidate channels is less than a threshold delay; and
marking a subset of candidate channels of the set of candidate channels for movement within the optical band, where a cumulative spectral width of the subset is at least equal to the spectral width for the new spectrum channel.

20. A system comprising:
a processor; and
a non-transitory computer-readable medium storing instructions which, when executed by the processor, cause the processor to perform operations, the operations comprising:
identifying a channel parameter and a distance for a new spectrum channel to be launched in an optical band in a fiber broadband network, wherein the optical band comprises a plurality of existing spectrum channels;
calculating a spectral width for the new spectrum channel, based at least in part on the channel parameter and the distance;
determining that a contiguous slice of the optical band is not available to support the spectral width for the new spectrum channel;
identifying, in response to the determining, a set of candidate channels of the plurality of existing spectrum channels, wherein each candidate channel of the set of candidate channels is a standby channel for a main channel and wherein a predicted network traffic delay associated with a movement of each candidate channel of the set of candidate channels is less than a threshold delay; and
marking a subset of candidate channels of the set of candidate channels for movement within the optical band, where a cumulative spectral width of the subset is at least equal to the spectral width for the new spectrum channel.
